(19) United States
(12) Patent Application Publication
(10) Pub. No.: US 2015/0348334 A1
(43) Pub. Date: Dec. 3, 2015

(54) TRAVEL DATA OF TRANSPORT SYSTEM USERS

(71) Applicant: MasterCard International Incorporated, Purchase, NY (US)

(72) Inventors: Lukas Ekselius, Overijse (BE); Sebastien Pochic, Schaerbeek (BE); Fikret Ates, Namur (BE)

(21) Appl. No.: 14/704,638

(22) Filed: May 5, 2015

(30) Foreign Application Priority Data
May 29, 2014 (GB) 1409499.9

(51) Int. Cl. G07B 15/02; H04W 4/00; H04W 40/24; H04W 4/02

(52) U.S. Cl. CPC G07B 15/02; H04W 4/023; H04W 4/008; H04W 40/244

(57) ABSTRACT

A method of generating travel data by a mobile device of a user of a transport system includes the mobile device receiving data transmitted from one or more beacons of the transport system; and generating travel data in dependence on the data received from the one or more beacons. The travel data is representative of the user's use of the transport system. The travel data may be used to reduce the burden on a user and to improve the services provided to a user.

### CROSS-RELATION TO RELATED APPLICATIONS

This application claims foreign priority to United Kingdom Patent Application 1409499.9, filed 29 May 2014, the complete disclosure of which is expressly incorporated herein by reference in its entirety for all purposes.

### FIELD OF THE INVENTION

The present invention relates generally, but not exclusively, to the generation of travel data for users of a transport system. More particularly, embodiments of the invention automatically generate travel data, that is representative of a user's journey on a transport system, in dependence on received data from beacons of the transport system. Uses of the travel data include the generation of details of a user's journey, the generation of transaction data for paying for a user's journey and the generation of recommendations for the user. Advantages include reducing the burden on users of a transport system and improving the services provided to users of a transport system.

### BACKGROUND TO THE INVENTION

Transport systems require users to carry a payment device, that may be a travel pass, in order to travel on the transport system.

The following describes a typical use of a payment device by a user of a transport system. At the start of their journey, the user presents their payment device on a reader/validator. This is sometimes referred to as ‘tapping-in’. When leaving the transport system at the end of their journey, the user again presents their payment device on a reader/validator. This is sometimes referred to as ‘tapping-out’. The fare for the user's journey may then be calculated in dependence on the start and end locations of the journey and payment for the user's journey made.

A problem experienced by users of a transport system when using a payment device as described above, is that each user of the transport system is burdened with the need to physically present their payment device when tapping-in and tapping-out of the transport system. This slows down the passage of users through the transport system. Retrieving and replacing a payment device from a pocket or bag also inconveniences users.

There is therefore a need to reduce the burden on users of a transport system. In addition, there is a need to provide users of a transport system with improved services.

### SUMMARY OF THE INVENTION

According to a first aspect of the invention, there is provided a method of generating travel data by a mobile device of a user of a transport system, the method comprising the mobile device: receiving data transmitted from one or more beacons of the transport system; and generating travel data in dependence on the data received from the one or more beacons, wherein the travel data is representative of the user's use of the transport system.

Preferably, the method further comprises the mobile device determining that the data received from each of the one or more beacons is data for use in generating travel data.

Preferably, the travel data is automatically generated in response to receiving data from one or more beacons.

Preferably, the data received from each of the one or more beacons is identification data and/or location data.

Preferably, the method further comprises the mobile device: determining the time that data from one or more of the beacons is received; wherein the travel data is generated further in dependence on one or more of the determined times.

Preferably, the method further comprises executing, by the mobile device, an application that controls the generation of the travel data in dependence on the data received from the one or more beacons.

Preferably, the method further comprises the mobile device generating transaction data in dependence on the travel data.

Preferably, the method further comprises the mobile device using the generated transaction data to perform a transaction by the mobile device.

Preferably performing a transaction comprises the mobile device transmitting the generated transaction data over a wireless communications network.

Preferably, the transaction data is payment data for paying for a journey of the user on the transport system.

Preferably, the generated travel data provides details on one or more journeys of the user of the transport system.

Preferably, the method further comprises the mobile device displaying data dependent on the travel data.

Preferably, the method further comprises the mobile device monitoring the travel data when the user is travelling on the transport system; detecting an event in dependence on the monitored travel data; and providing the user with an indication that the event has occurred.

Preferably, the method further comprises the mobile device transmitting the travel data to a server over a wireless communications network.

Preferably, the method further comprises receiving a response to the transmitted travel data from the server.

Preferably, at least one of the one or more beacons is in a fixed, non-mobile, location.

Preferably, at least one of the one or more beacons is in a fixed, mobile, location.

Preferably, the one or more beacons are Bluetooth Low Energy, BLE, beacons.

Preferably, the mobile device is at least one of a mobile telephone, sticker, watch, key fob or any other form factor that is capable of generating travel data of the user.

Preferably, the transport system is a bus system, train system, tram system, airport or boat service.

According to a second aspect of the invention, there is provided a mobile device configured to perform the method of the first aspect.

According to a third aspect of the invention, there is provided a transport system comprising a plurality of beacons and one or more mobile devices according to the second aspect, wherein each of the beacons is configured to transmit data for the generation of travel data by the one or more mobile devices.

Preferably, the beacons are Bluetooth Low Energy, BLE, beacons.

Preferably, the transport system is a bus system, train system, tram system, airport or boat service.

### BRIEF DESCRIPTION OF DRAWINGS

Embodiments of the present invention will now be described, by way of example only, with reference to the accompanying drawings, in which:

FIG. 1 shows a system according to an embodiment of the invention; and

FIG. 2 shows a flowchart according to an embodiment of the invention.

### DETAILED DESCRIPTION

Embodiments of the invention reduce the burden on users of a transport system by allowing users to travel on the transport system without ever being required to present a device to a reader/validator. In addition, embodiments provide improved services to users of a transport system.

According to embodiments, a transport system comprises a plurality of beacons that transmit data. The transmitted data by each beacon may be only identification data and/or location data of the beacon. The data is transmitted at a low power so that it is only received by devices within a short range of the beacon.

Users of the transport system carry a mobile device. The mobile device is a mobile communications device, such as mobile telephone, that is capable of receiving the transmitted data from a beacon and generating travel data representative of a user's journey on the transport system in dependence on the received data. The mobile device would typically be carried in a pocket or bag of the user.

When the user enters the transport system, the mobile device passes within range of a beacon and receives the data transmitted by the beacon. Similarly, when exiting the transport system, the user's mobile device passes within range of another beacon and receives the data transmitted by said another beacon. The mobile device is able to receive the data from the beacons 101 from within the user's pocket or bag. It is not necessary for the user to retrieve the mobile device or in any way physically present the mobile device to a reader/validator. The mobile device then generates travel data in dependence on the received data from one or both of the beacons.

The travel data may be used by the mobile device to reduce the burden on a user and to improve the services provided to a user.

For example, the mobile device may use the travel data to generate transaction data for paying for the user's journey. Payment of the journey may be automatically made by the mobile device by, for example, transmitting the transaction data over a wireless communications network 103 according to known wireless payment techniques by mobile devices.

The mobile device may use the travel data to generate details of the user's journey on the transport system. Such details may be required, for example, in order for a user to prove to an inspector on the transport system that the user has used the transport system in accordance with the conditions of their travel pass.

Advantageously, users of the transport system may enter and leave the transport system and pay for their journey without ever being required to physically present any type of device or retrieve a device from a pocket or bag. This improves the efficiency of the passage of users through the transport system and reduces the burden on each user.

The automatic generation of travel data also allows improved services to be provided to a user of a transport system. For example, the travel data may be used to automatically generate a message that reminds a user to exit the transport system at the next station.

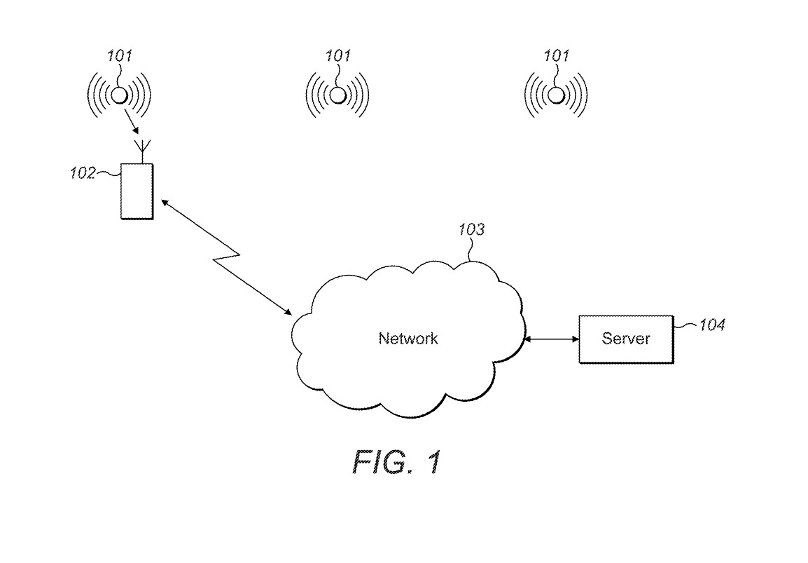

Embodiments of the invention are described in more detail below with reference to FIG. 1.

FIG. 1 shows a system according to an embodiment. The system comprises a plurality of beacons 101 of a transport system, a mobile device 102 of a user, a communications network 103 and a server 104.

All the beacons 101 are transmitting data over a short range. The mobile device 102 is shown within range of only one of the beacons 101 and is able to receive the transmitted data by the beacon 101 but unable to receive data from the other two beacons 101. The mobile device 102 is able to communicate wirelessly with the network 103, which is a standard wireless network 103 for supporting communications with a mobile device 102. The network 103 may be connected to one or more further networks or servers 104 for providing services, such as payments initiated by the mobile device 102.

Beacons 101, according to embodiments, are devices that only transmit data. The data is pushed to other devices within range of the beacon 101 and may be transmitted continuously or periodically.

The beacons 101 are preferably Bluetooth Low Energy, BLE, beacons 101. These beacons 101 use Bluetooth communication to transmit data. Preferably, only a small amount of data is repeatedly transmitted. The transmitted data may only be identification data, such as a serial number, and/or location data of the beacon 101.

The range of a beacon 101 may be as far as about 50 m or as low as 1 m or less. The range of the beacon 101 is dependent on the power that the beacon 101 is configured to transmit at. A system operator will set an appropriate power level for the beacon 101 in dependence on its location and intended purpose. The beacons 101 are typically physically small and can be battery operated. The transmitted power level from each beacon 101 is low and the battery would typically not need to be recharged or replaced for about two years.

The beacons 101 do not require complicated, high power, data processing circuitry and the beacons 101 are easy to operate. The cost of manufacturing and using a beacon 101 is low. The small physical size of beacons 101, and option of battery operation, means that an existing transport system can be easily adapted to include a large number of beacons 101 provided at appropriate locations within the transport system.

Embodiments are applicable to any type of transport system, such as a bus system, train system, tram system, airport or boat service.

The transport system may provide beacons 101 at all of the entrances and exits of the transport system, such as at train stations or bus stops. The beacons 101 are located, and arranged to transmit data at an appropriate power, so that substantially all of the mobile devices 102 of users of the transport system pass within range of at least one beacon 101 when they use the transport system.

Beacons 101 may also be provided on the vehicles of a transport system, such as on trains and on busses, as well as any other locations within the transport system that users travel past. For example, beacons 101 may be provided within range of all, or any, of the doors, seats and corridors of a train or bus. By providing beacons 101 at such locations within a transport system, it is possible for the journey of user to be tracked based on the data the user's mobile device 102 has received from beacons 101.

The mobile device 102 carried by a user may be any type of mobile telephone, such as a smart phone, or any other type of mobile device 102 that is capable of receiving data from a beacon 101 and generating travel data. For example, the mobile device 102 may be a sticker, key fob, watch or any other suitable form factor.

In response to receiving data from a beacon, the mobile device 102 determines that the received data corresponds to a beacon 101 of the transport system and has not been received from a beacon 101 used for a different purpose. For example, the transmitted identification data from beacons 101 of the transport system may comprise identification data that is unique to the transport system that the mobile device 102 compares against stored data thereon to determine that the received data is from a beacon 101 of the transport system. System recognition from received data is well known in the art many other techniques may also be used in order for a mobile device 102 to determine that the received data from a beacon 101 is a beacon 101 of a transport system.

During a journey of a user on the transport system, the mobile device 102 stores the data received from one or more beacons 101 of the transport system. The mobile device 102 automatically uses the data to generate travel data, that is representative of the user's use of the transport system, in dependence on some, or all, of the received data from the beacons 101. For example, the generated travel data may be dependent on entry and exit locations of the transport system by the user, the entry and exit locations being determined form data received by beacons 101. The data received from the beacons 101 may also be used to determine how many journeys that a user has made on the transport system and the generated travel data correspond to one or more journeys. The travel data may also be generated further in dependence on data other than that received from the beacons 101. For example, the travel data may be generated in dependence on received data form one or more beacons 101 as well as time that the data from each beacon 101 is received by the mobile device 102, the time data being generated by the mobile device 102. The travel data may also be generated in dependence on location data, or any other type of data, obtained by the mobile device 102 by other means than a beacon 101 of the transport system.

In a particularly preferred implementation, the mobile device 102 automatically generates transaction data in dependence on the travel data. The mobile device 102 may already have stored thereon any additional data, such as price data, and programs required for generating the transaction data and/or the mobile device 102 may download any required data and programs from the network 103.

The mobile device 102 may use the generated transaction data to pay for the journey of the user. The payment may be made in response to an instruction from the user but is preferably made automatically with the data received from a beacon 101 acting a trigger for starting an automatic process that ends with a payment being made. The payment may be a wireless payment made by the mobile device 102 transmitting the transaction data, over a mobile telephone network 103, to a server system for performing a payment. Such a wireless payment system by a mobile device 102 is known and is provided, for example, by the payment systems of MasterCard®.

Alternatively, the account balance of the user may be maintained on the mobile device 102. In this implementation, the mobile device 102 would reduce the account balance stored on the mobile device 102 in dependence on the transaction data to pay for the journey.

In another preferred implementation, the travel data provides details of a user's journey on the transport system, such as in the form of a log or record. Embodiments include the use of the travel data to provide enhanced services, as discussed below.

The travel data of one or more journeys may be displayed on the mobile device 102 so that a user can see when and where they were.

The user of the mobile device 102 may have a travel pass with use conditions that allow the user to travel without paying on some, but not all, journeys on a transport system. The user can then enter and exit the transport system without being inconvenienced by physically presenting a travel pass, i.e. tapping in and tapping out. An inspector on the transport can verify that the user is using the transport system in accordance with the use conditions of the travel pass by reading the travel data.

The transport system may be that of an airport or boat service and travel data may be used to automatically generate data for checking-in and/or checking-out the user by the mobile device 102.

The travel data may be updated in real-time as the user travels on a transport system. The mobile device 102 may have already been informed of a user's intended journey, or determined the expected user's journey from travel data obtained from previous journeys of the user, and determine an event to be the user arriving at a location. By monitoring the travel data for the event occurring, the mobile device 102 may automatically generate a message, or provide other types of indication possible with a mobile device 102, reminding the user that they are at, or approaching, the location at the user should leave the transport system.

The travel data may also be used to make recommendations to a user. For example, the mobile device 102 may download performance data on the current performance of the transport system. The mobile device 102 may determine from the performance data and real-time travel data that it would be beneficial for the user to use an alternative route through the transport system. A message, or other type of indication, recommending that the user takes an alternative route through the transport system to reach their intended exit may then be automatically generated.

The travel data may be transmitted over a wireless communications network 103 from the mobile device 102 to a remote server 104. The server 104 can then use the travel data to provide more targeted services to the user. In particular, the server 104 may perform any of the above-described operations, such as performing a transaction, generating messages and/or recommendations. The messages and recommendations would then be transmitted from the server 104 to the mobile device 102.

In another particularly preferred implementation, the mobile device 102 executes an application, usually referred to as an App. The App configures the mobile device 102 to detect the transmitted data from the beacons 101 and to generate travel data. Either the same App, or one or more additional Apps, may also configure the mobile device 102 to perform all, or any, of the above-described further operations, such as to generate transaction data. The mobile device 102 may be configured by the App(s) to perform all, or any, of the operations automatically. The App(s) may be downloadable by the mobile device 102.

Embodiments therefore greatly reduce the burden on users of a transport system since users may travel on a transport system without ever being required to physically present any type of payment device or travel pass. In addition, the travel data generated from the beacons 101 improves the services that may be provided to a user.

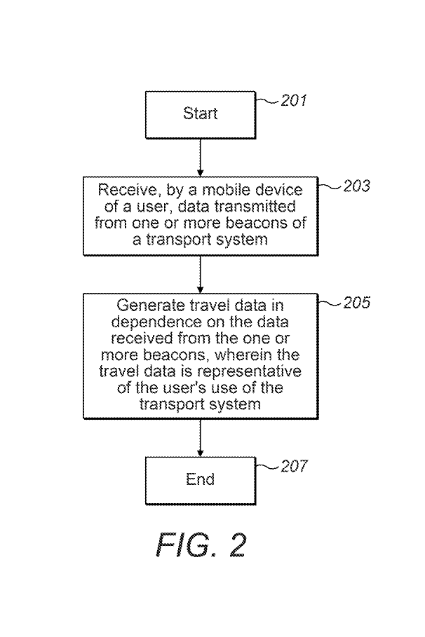

FIG. 2 is a flow chart showing processes performed by a mobile device 102 according to an embodiment of the invention.

In step 201, the process begins.

In step 203, the data transmitted from one or more beacons 101 of a transport system is received by a mobile device 102 of a user.

In step 205, travel data is generated in dependence on the data received from the one or more beacons 101, wherein the travel data is representative of the user's use of the transport system.

In step 207, the process ends.

A number of modifications and variations can be made to the above-described embodiments without departing from the scope of embodiments of the invention.

Embodiments have been described with reference to transport systems. Although this is a particularly preferred implementation, embodiments include all, or any, of the above-described techniques being applied in other scenarios, such as in stadiums, theme parks and at events. Transmitted data from beacons 101 is used to provide enhanced services to users. For example, the travel data may be representative of locations of a user within a stadium or at an event. The data received from beacons 101 may be used to provide recommendations to the user based on the travel data, such as where to proceed to next given their current location. The received data may also trigger the generation of transaction data for payments by the user, as described above.

In the above-described embodiments, beacons 101 are described as being provided at both the entrance and exits of a transport system. Embodiments also include only providing beacons 101 at only the entrance or exit of a transport system. This would be appropriate for a transport system in which all journeys cost the same.

In the above described embodiments, beacons 101 are described as transmitting identification and/or location data. The identification data may be in the form of a serial number and provide the identification of any, or all, of the transport system, a location within the transport system, a vehicle of the transport system, the beacon 101 itself, or other features. The location data may a fixed, non-mobile, geographical location, such as the location of the entrance or exit of a station. The location data may also be that of a fixed, mobile, location, such as the entrance or exit of a vehicle of a transport system. Beacons 101 are in no way restricted to transmitting only identification and location data and may also transmit, for example, time data or messages, such as offers to users.

The beacons 101 may be any form of wireless transmitter of a signal that is detectable by a mobile device 102. For example the beacons 101 may be WiFi transmitters, sound transmitters, or any other type of signal transmitters.

In the above-described embodiments, the travel data is generated and stored on the mobile device 102. Embodiments also include the mobile device 102 transmitting the data received from one or more beacons 101 over a wireless communications network 103 to a remote server 104. The travel data is then generated at the server 104 and further operations, such as making a payment or generating recommendations, performed by the server 104. This reduces the processing requirements at the mobile device 102. The server 104 may transmit data back to the mobile device 102, as appropriate for the processes performed at the server 104. The data may be transmitted from the mobile device 102 to the remote server 104 in real-time or in a batch.

According to embodiments, the travel data generated by a mobile device 102 may be considered to be context data. The context data provides information on where, when and what the notifications from beacons 101 have been received for. The mobile device 102 may store the context data for later incremental processing by the mobile device 102 or a remote sever 104.

All of the processes of embodiments described throughout the present document may be automated. However this is not essential and some of the processes may not be automated.

The flow chart and description thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1. A method of generating travel data by a mobile device of a user of a transport system, the method comprising the mobile device:
receiving data transmitted from one or more beacons of the transport system; and
generating travel data in dependence on the data received from the one or more beacons, wherein the travel data is representative of the user's use of the transport system.

2. The method according to claim 1, further comprising the mobile device determining that the data received from each of the one or more beacons is data for use in generating travel data.

3. The method according to claim 1, wherein the travel data is automatically generated in response to receiving data from one or more beacons.

4. The method according to claim 1, wherein the data received from each of the one or more beacons is identification data and/or location data.

5. The method according to claim 1, further comprising the mobile device:
determining the time that data from one or more of the beacons is received;
wherein the travel data is generated further in dependence on one or more of the determined times.

6. The method according to claim 1, further comprising executing, by the mobile device, an application that controls the generation of the travel data in dependence on the data received from the one or more beacons.

7. The method according to claim 1, further comprising the mobile device generating transaction data in dependence on the travel data.

8. The method according to claim 7, further comprising the mobile device using the generated transaction data to perform a transaction by the mobile device.

9. The method according to claim 8, wherein performing a transaction comprises the mobile device transmitting the generated transaction data over a wireless communications network.

10. The method according to claim 7, wherein the transaction data is payment data for paying for a journey of the user on the transport system.

11. The method according to claim 1, wherein the generated travel data provides details on one or more journeys of the user of the transport system.

12. The method according to claim 1, further comprising the mobile device displaying data dependent on the travel data.

13. The method according to claim 1, further comprising the mobile device monitoring the travel data when the user is travelling on the transport system;
detecting an event in dependence on the monitored travel data; and
providing the user with an indication that the event has occurred.

14. The method according to claim 1, further comprising the mobile device transmitting the travel data to a server over a wireless communications network.

15. The method according to claim 14, further comprising receiving a response to the transmitted travel data from the server.

16. The method according to claim 1, wherein at least one of the one or more beacons is in a fixed, non-mobile, location.

17. The method according to claim 1, wherein at least one of the one or more beacons is in a fixed, mobile, location.

18. The method according to claim 1, wherein the one or more beacons are Bluetooth Low Energy, BLE, beacons.

19. The method according to claim 1, wherein the mobile device is at least one of a mobile telephone, sticker, watch, key fob or any other form factor that is capable of generating travel data of the user.

20. The method according to claim 1, wherein the transport system is a bus system, train system, tram system, airport or boat service.

21. A mobile device configured to:
receive data transmitted from one or more beacons of a transport system; and
generate travel data in dependence on the data received from the one or more beacons, wherein the travel data is representative of the user's use of the transport system.

22. A transport system comprising:
a plurality of beacons; and
one or more mobile devices, each of said one or more mobile devices being configured to:
receive data transmitted from the beacons of the transport system; and
generate travel data in dependence on the data received from the beacons, wherein the travel data is representative of the user's use of the transport system;
wherein each of the beacons is configured to transmit data for the generation of travel data by the one or more mobile devices.

23. The transport system according to claim 22, wherein the beacons are Bluetooth Low Energy, BLE, beacons.

24. The transport system according to claim 22, wherein the transport system is a bus system, train system, tram system, airport or boat service.
